(19) United States
(12) Patent Application Publication
(10) Pub. No.: US 2012/0143797 A1
(43) Pub. Date: Jun. 7, 2012

(54) Metric-Label Co-Learning

(75) Inventors: Meng Wang, Singapore (SG); Xian-Sheng Hua, Beijing (CN); Bo Liu, Hong Kong (CN)

(73) Assignee: Microsoft Corporation, Redmond, WA (US)

(21) Appl. No.: 12/961,124

(22) Filed: Dec. 6, 2010

(51) Int. Cl. G06F 15/18; G06N 5/02

(52) U.S. Cl. 706/12; 706/52

(57) ABSTRACT

Labels for unlabeled media samples may be determined automatically. Characteristics and/or features of an unlabeled media sample are detected and used to iteratively optimize a distance metric and one or more labels for the unlabeled media sample according to an algorithm. The labels may be used to produce training data for a machine learning process.

### BACKGROUND

Recent years have witnessed an explosive growth of multimedia data and large-scale image/video datasets readily available on the Internet. However, organizing media on the Internet still remains a challenge to the multimedia community. Manual classification and organization of media on the Internet represents a very labor intensive and time consuming task.

Automated classification and organization techniques may take advantage of machine learning algorithms. Machine learning algorithms may assist in classifying and organizing images and videos on the Internet by automating at least a portion of image/video labeling, classifying, indexing, annotating, and the like. However, machine learning algorithms frequently suffer from insufficient training data and/or an inappropriate distance metrics. When training data is insufficient, learned models based on the training data may not be accurate, negatively affecting the overall accuracy of a classification technique using the learned models.

Additionally, many machine learning algorithms heuristically adopt a Euclidean distance metric. The Euclidean distance metric may not be appropriate for a specific learning task, such as classifying images or videos. Using an inappropriate distance metric may degrade the accuracy of classifications based on the distance metric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, this disclosure describes automatically determining a label for an unlabeled media sample (e.g., a video, an image, an audio clip, etc.). The determining includes detecting characteristics and/or features from a received media sample and optimizing a distance metric and a label for the media sample based on the detected characteristics and/or features. In one embodiment, the distance metric and the label are optimized using an iterative converging algorithm. The optimized label is output (for example, to a user) when the algorithm converges. In one embodiment, the output includes training data configured to train a machine learning process.

In alternate embodiments, the distance metric and the label are optimized simultaneously during each iteration of the algorithm.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a system that determines a label for a media sample, including example system components, according to an example embodiment.

FIG. 2 illustrates a block diagram of an example analysis component according to the example embodiment of FIG. 1.

FIG. 3 illustrates an example methodology of determining a label for a media sample, according to an example embodiment.

### DETAILED DESCRIPTION

Various techniques for determining a label for an unlabeled media sample are disclosed. For ease of discussion, the disclosure describes the various techniques with respect to images and/or videos. However, the descriptions also may be applicable to classifying or determining labels for other objects such as web data, audio files, and the like.

### Overview

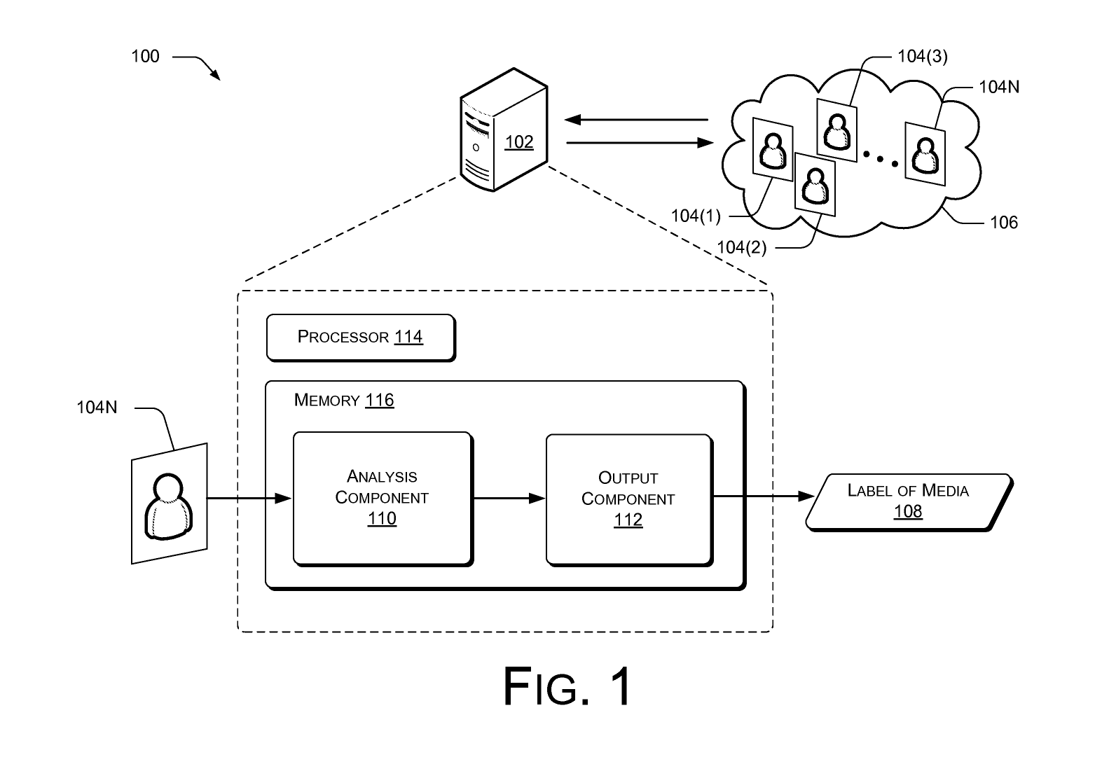

In general, an iterative technique may be applied to automatically determine a label for an unlabeled image/video (media sample). FIG. 1 is a block diagram of an arrangement 100 that is configured to determine a label for an unlabeled media sample, according to an example embodiment. In one embodiment, a system 102 receives unlabeled media samples and outputs a label for the unlabeled media sample. In alternate embodiments, fewer or additional inputs may be included (e.g., feedback, constraints, etc.). Additionally or alternately, other outputs may also be included, such as a set of training data, a classification system, an index, and the like.

In the example embodiment of FIG. 1, the system 102 receives an unlabeled media sample 104 (media samples are shown in FIG. 1 as 104(1), 104(2), 104(3) . . . 104N). The media sample 104 may include one of various forms of media, including an image, a video, an audio segment, web data, and the like. In various implementations, the media sample 104 may be included as part of a search query (e.g., an automated query, a user query, etc.). In other implementations, the media sample 104 may reside in a local or remote database. For example, a user (or an automated system) may submit the media sample 104 to the system 102 to determine a label for the media sample 104.

In one embodiment, the system 102 may be connected to a network 106, and may search the network 106 for unlabeled media samples 104. The system 102 may search for the unlabeled media samples 104 to provide labels for them, index them, classify them, or the like. In an embodiment, the system 102 stores one or more unlabeled media samples 104 found on the network 106. In alternate embodiments, the network 106 may include a network (e.g., wired or wireless network) such as a system area network or other type of network, and can include several nodes or hosts, (not shown), which can be personal computers, servers or other types of computers. In addition, the network can be, for example, an Ethernet LAN, a token ring LAN, or other LAN, a Wide Area Network (WAN), or the like. Moreover, such network can also include hardwired and/or optical and/or wireless connection paths. In an example embodiment, the network 106 includes an intranet or the Internet.

The media samples 104 (shown in FIG. 1 as 104(1) through 104N) represent various images/videos, etc. that may have been stored in one or more locations on the network 106 or that may be accessed via the network 106. In alternate embodiments, one or more of the media samples 104 may be duplicates. While FIG. 1 illustrates media samples 104(1)-104(N), in alternate embodiments, the system 102 may find and/or store fewer or greater numbers of media samples 104, including hundreds, thousands, or millions of media samples 104 (where N represents the number of media samples). The number of media samples 104 stored in one or more locations on the network 106 or that may be accessed via the network 106 may be based on the number of media samples 104 that have been posted to the Internet, for example.

In an example embodiment, the system 102 determines a label 108 for a media sample 104 based on an iterative algorithm that will be discussed further. Additionally or alternately, the system 102 may employ various techniques to determine the label 108, including the use of support vector machines, statistical analysis, probability theories, and the like. In one embodiment, the system 102 outputs the label 108. For example, the system 102 may output the label 108 to a user, a process, a system, or the like. Additionally or alternately, the system 102 may output a set of training data for training a machine learning technique. Other outputs may include a classification system, an index, an information database, and the like. For example, the system 102 may determine labels for unlabeled media samples 104 to provide organization to the extensive media data on the Internet.

### Example Metric-Labeling Optimization System

Example label determination systems are discussed with reference to FIGS. 1-3. FIG. 1 illustrates a block diagram of the system 102, including example system components, according to one embodiment. In one embodiment, as illustrated in FIG. 1, the system 102 is comprised of an analysis component 110 and an output component 112. In alternate embodiments, the system 102 may be comprised of fewer or additional components and perform the discussed techniques within the scope of the disclosure.

All or portions of the subject matter of this disclosure, including the analysis component 110 and/or the output component 112 (as well as other components, if present) can be implemented as a system, method, apparatus, or article of manufacture using standard programming and/or engineering techniques to produce software, firmware, hardware or any combination thereof to control a computer or processor to implement the disclosure. For example, an example system 102 may be implemented using any form of computer-readable media (shown as memory 116 in FIG. 1) that is accessible by the processor 114 and/or the system 102. Computer-readable media may include, for example, computer storage media and communications media.

Computer-readable storage media includes volatile and nonvolatile, removable and non-removable media implemented in any method or technology for storage of information such as computer-readable instructions, data structures, program modules or other data. Memory 116 is an example of computer-readable storage media. Additional types of computer-readable storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may accessed by the processor 114.

In contrast, communication media typically embodies computer readable instructions, data structures, program modules, or other data in a modulated data signal, such as a carrier wave, or other transport mechanism.

While the subject matter has been described above in the general context of computer-executable instructions of a computer program that runs on a computer and/or computers, those skilled in the art will recognize that the subject matter also may be implemented in combination with other program modules. Generally, program modules include routines, programs, components, data structures, and the like, which perform particular tasks and/or implement particular abstract data types.

Moreover, those skilled in the art will appreciate that the innovative techniques can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. For example, one or more of the processor 114 and/or the memory 116 may be located remote from the system 102. However, some, if not all aspects of the disclosure can be practiced on stand-alone computers. In a distributed computing environment, program modules may be located in both local and remote memory storage devices (such as memory 116, for example).

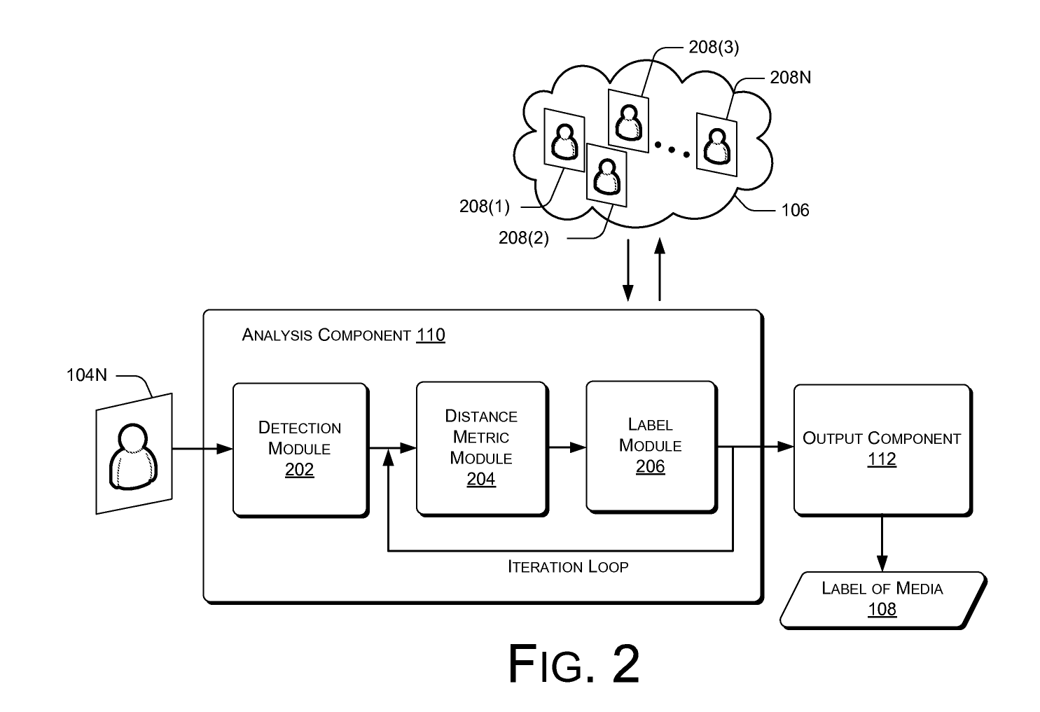

In one example embodiment, as illustrated in FIG. 2, the analysis component 110 is comprised of a detection module 202, a distance metric module 204, and a label module 206. In alternate embodiments, the analysis component 110 may be comprised of fewer or additional modules and perform the discussed techniques within the scope of the disclosure. Further, in alternate embodiments, one or more of the modules may be remotely located with respect to the analysis component 110. For example, a module (such as the detection module 202, for example) may be located at a remote network location.

Referring to FIG. 2, in the example embodiment, the analysis component 110 receives an unlabeled media sample 104N. If included, the detection module 202 (as shown in FIG. 2) may provide detection of features and/or characteristics of the media sample 104N to the system 102. For example, the detection module 202 may use various techniques (e.g., text recognition, image recognition, web-based search, graphical comparisons, color or shape analysis, line/vector analysis, audio sampling, etc.) to detect the features and/or characteristics of the media sample 104N. As illustrated in FIG. 1, the system 102 may be connected to a network 106, and may query the network 106 to assist in detecting and identifying features and characteristics of the media sample 104. Detected features and characteristics may be based on the type of media represented by the media sample 104N. For example, if the media sample 104N is an image, the features and characteristics may include colors, shapes, persons, places, objects, events, text, and the like. If, for example, the media sample 104N is a video, the features and characteristics may include persons, places, activities, events, music, sound, objects, timeline, production features, color, motion, texture, etc. In one embodiment, the media sample 104 and/or the features and/or characteristics may be stored on the memory 116, or similar electronic/optical storage that is local or remote to the system 102 and accessible to the processor 114.

In various embodiments, the system 102 may use the detected features and/or characteristics of the media sample 104 to determine a label for the media sample 104. If included, the distance metric module 204 and/or the label module 206 may iteratively process the detected features and characteristics of the unlabeled media sample 104 with respect to one or more other unlabeled media samples 104 or known labeled media samples 208 (as shown in FIG. 2). In various embodiments, the labeled media samples 208 (shown in FIG. 2 as 208(1), 208(2), 208(3) . . . 208N) may be accessed from a network (such as network 106, for example), from a local or remote memory storage device (such as memory 116, for example), from a prepared database, or the like. In one embodiment, the distance metric module 204 and the label module 206 optimize a distance metric and a label for the unlabeled media sample 104 using an iterative converging algorithm as discussed below.

In one embodiment, the output of the system 102 is displayed on a display device (not shown). In alternate embodiments, the display device may be any device for displaying information to a user (e.g., computer monitor, mobile communications device, personal digital assistant (PDA), electronic pad or tablet computing device, projection device, imaging device, and the like). For example, the label 108 may be displayed on a user's mobile telephone display. In alternate embodiments, the output may be provided to the user by another method (e.g., email, posting to a website, posting on a social network page, text message, entered into a database, forwarded to a classification/indexing system, etc.).

### Metric-Label Co-Learning Overview

In alternate embodiments, one or more of various algorithms may be used to determine a label 108 for the unlabeled media sample 104. In some embodiments, more than one label may be correct for an unlabeled media sample 104. For example, a media sample 104 may include many features and characteristics (e.g., persons, places, activities, events, music, sound, objects, timeline, production features, color, motion, texture, etc.), giving rise to multiple labels based on the features and characteristics. Those features and characteristics of the unlabeled media sample 104 that are close to similar features and characteristics of a labeled sample 208 may be used to label the unlabeled sample 104 in like manner to the labeled sample 208. Accordingly, there may be more than one “correct” label 108 for a media sample 104 having multiple characteristics.

Determining labels 108 for a media sample 104, based on how close its features and characteristics are to those of a labeled sample 208 may be automated using machine learning techniques. Generally, the use of a lesser number of known labeled media samples 208 to determine labels for a much greater number of unlabeled media samples 104 may be described in terms of semi-supervised machine learning. For example, the number of known labeled media samples 208 may be on the order of ten thousand samples when the number of unlabeled media samples 104 is on the order of one million samples. In various embodiments, machine learning techniques may include the use of a support vector machine (SVM), or the like.

In general, machine learning algorithms may suffer from an insufficiency of training data and an inappropriate distance metric. In alternate embodiments, semi-supervised learning may be applied to machine learning algorithms to mitigate insufficient training data and distance metric learning may be applied to machine learning algorithms to mitigate an inappropriate distance metric. In other words, distance metric learning may provide an optimal distance metric for a given learning task based on pair wise relationships among the training samples (e.g., how close a pair of neighboring samples are to each other). For example, some distance metric methods attempt to construct a metric under which the sample pairs with equivalence constraints (such as sample pairs with the same labels) are closer than those with inequivalence constraints (the sample pairs have different labels).

As another illustrative example, graph-based (samples plotted on a two or three dimensional graph) semi-supervised learning generally assumes that the labels of nearby samples should be close. The determination of sample similarity (or what is “close”) may highly impact the learning performance. In some cases, Euclidean distance is applied and the similarity of samples is based on a radius parameter σ, where samples within the radius a are determined to be “close.” However, this method may not be optimal, and a better distance metric may significantly improve the learning performance.

Accordingly, in one embodiment, a Metric-Label Co-Learning (MLCL) approach is used that simultaneously optimizes a distance metric and the labels of unlabeled media samples 104. In one implementation, a Mahalanobis distance metric is used to determine whether the labels of nearby samples (labeled and/or unlabeled samples) are close. A general regularization framework can be written as:

$${min}_{f , M} g ( f , M , {x}_{1} , {x}_{2} , … , {x}_{n} ) + μ {\sum }_{i = 1}^{l} V ( {x}_{i} , {y}_{i} , f ) , s . t . M \geq 0$$

Where the term g(f, M, x₁, x₂, . . . , xₙ) indicates the smoothness of labels under the distance metric M, and the term V(xᵢ,yᵢ, f) represents a fitting constraint, which means that the classification function should not change too much from the labels on the training samples.

In one embodiment, a MLCL algorithm is used to compute a vector score for each potential label for an unlabeled media sample 104 (as described further with corresponding equations below). The vector scores may be based at least in part on the features and/or characteristics of the unlabeled media sample. In alternate embodiments, the vector scores may be positive, negative, or neutral. In an implementation, a threshold is predetermined for comparison to the vector scores, such that a label is applied to (determined for) the unlabeled media sample 104 when the vector score for the label meets or exceeds the threshold, and the label is not applied if the vector score for the label does not at least meet the threshold. In an embodiment, a label may propagate from a sample to its neighboring samples based on the similarity of the features and/or characteristics of the neighboring samples. In one embodiment, the distance between neighboring samples for propagation of a label is optimized through an iterative algorithm.

The coupling of semi-supervised learning (with respect to labels) and distance metric learning in MLCL has multiple advantages: (1) It is a semi-supervised algorithm and can leverage a large amount of unlabeled data, and thus a potential training data insufficiency problem can be mitigated for the learning of labels and a distance metric; (2) In comparison with methods that apply Euclidean distance, a more appropriate (accurate) distance metric can be constructed using MLCL and, thus, better learning performance can be achieved; and (3) In comparison with most methods that use a radius parameter to compute similarity measurement (such as radius parameter σ), embodiments using a MLCL algorithm can learn the scaling without a specified radius parameter and avoid the difficulty of parameter tuning. Thus, in alternate embodiments, a MLCL algorithm may be generally parameter-free. While a few advantages have been listed, employing the MLCL techniques may result in more or fewer advantages over existing techniques, depending upon the particular implementation.

In some instances, further advantages to a MLCL algorithm include that it may be applied to reduce feature dimensionality. By forcing a learned metric to be a low rank, a linear embedding function can be obtained, where MLCL is applied as a semi-supervised embedding algorithm.

### Example Metric-Label Co-Learning Algorithm

In one embodiment, a MLCL algorithm is derived from a graph-based semi-supervised learning technique. In an example graph-based (K-class classification) semi-supervised learning problem, there are l labeled samples (x₁,y₁), . . . , (xₗ, yₗ) (yε{1, 2, 3, . . . , K}, xεR^{D}), and u unlabeled samples xₗ₊₁, . . . , xₗ₊ᵤ. Let n=1+u be the total number of samples. Denote by W an n×n affinity matrix with Wᵢⱼ indicating the similarity measure between xᵢ and xⱼ (where xᵢ and xⱼ represent features and/or characteristics of media samples, including unlabeled media samples 104 and/or labeled media samples 208) and Wᵢᵢ is set to 0. Denote by D a diagonal matrix with its (i, i)-element equal to the sum of the i-th row of W. Define an n×K label matrix Y where Yᵢⱼ is 1 if xᵢ is a labeled sample and belongs to class j, and 0 otherwise. Define an n×K matrix F=[F₁^{T}, F₂^{T}, . . . , F_{N}^{T}]^{T}, where Fᵢⱼ is the confidence of xᵢ with label yⱼ. Apply a classification rule including assigning each sample xᵢ a label yᵢ=arg max_{j≦k} Fᵢⱼ. A Learning with Local and Global Consistency (LLGC) algorithm is used to minimize the following cost function:

$$Q = {\sum }_{i , j = 1}^{n} {W}_{ij} {‖ \frac{{F}_{i}}{\sqrt{{D}_{ii}}} - \frac{{F}_{j}}{\sqrt{{D}_{jj}}} ‖}^{2} + μ {\sum }_{i = 1}^{n} {‖ {F}_{i} - {Y}_{i} ‖}^{2}$$

There are two terms in this regularization scheme, where the first term implies the smoothness of the labels on the graph and the second term indicates the constraint of training data. The solution of this equation is:

$$F = \frac{μ}{1 + μ} {( I - \frac{S}{1 + μ} )}^{- 1} Y$$

where S=D^{-1/2}WD^{-1/2} .

In one embodiment, to integrate metric learning and label learning, the Euclidean distance metric is replaced with a Mahalanobis distance metric as discussed above, which results in:

Wᵢⱼ=exp(−(xᵢ−xⱼ)^{T}M(xᵢ−xⱼ))

where M is a symmetric positive semi-definite real matrix. M may be decomposed as M=A^{T}A, and substituted into the previous equation, which thus becomes:

Wᵢⱼ(A)=exp(−∥A(xᵢ−xⱼ∥²)

F and A are then simultaneously optimized (as performed by distance metric module 204 and label module 206 in FIG. 2, for example), obtaining the formulation of MLCL as:

$$Q ( F , A ) = {\sum }_{i , j = 1}^{n} {W}_{ij} ( A ) {‖ \frac{{F}_{i}}{\sqrt{{D}_{ii}}} - \frac{{F}_{j}}{\sqrt{{D}_{jj}}} ‖}^{2} + μ {\sum }_{i = 1}^{n} {‖ {F}_{i} - {Y}_{i} ‖}^{2} \\ [ {F}^{*} , {A}^{*} ] = {argmin}_{F , A} Q ( F , A )$$

where F represents the optimization of the label of the media sample 104 and A represents the optimization of the distance metric. In one embodiment, an iterative process which alternates a metric update step (using, for example, distance metric module 204) and a label update step (using, for example, label module 206) is used to solve the formulation of MLCL. In an implementation, a gradient descent method may be used to update the matrix A (i.e., the metric update step). The derivative of Q(F, A) with respect to A may be simplified to the form:

$$\begin{matrix}\begin{matrix}\frac{\partial Q ( F , A )}{\partial A} = \frac{\partial }{\partial A} [ {\sum }_{i , j = 1}^{n} {W}_{ij} {‖ \frac{{F}_{i}}{\sqrt{{D}_{ii}}} - \frac{{F}_{j}}{\sqrt{{D}_{jj}}} ‖}^{2} + μ {\sum }_{j = 1}^{n} {‖ {F}_{j} - {Y}_{j} ‖}^{2} ] \\ = {\sum }_{i , j = 1}^{n} \frac{\partial }{\partial A} \{ {W}_{ij} {‖ \frac{{F}_{i}}{\sqrt{{D}_{ii}}} - \frac{{F}_{j}}{\sqrt{{D}_{jj} }} ‖}^{2} \} \\ = {\sum }_{i , j = 1}^{n} \{ \frac{\partial {W}_{ij}}{\partial A} {‖ {c}_{ij} ‖}^{2} - {W}_{ij} ( \frac{{c}_{ij}^{T} {F}_{i}}{\sqrt{{D}_{ii}^{3}}} \frac{\partial {D}_{ii}}{\partial A} - \frac{{c}_{ij}^{T} {F}_{j}}{\sqrt{{D}_{jj}^{3}}} \frac{\partial {D}_{jj}}{\partial A} ) \}\end{matrix} & \\ where \\ {c}_{ij} = \frac{{F}_{i}}{\sqrt{{D}_{ii} }} - \frac{{F}_{j}}{\sqrt{{D}_{jj}}} \\ \frac{\partial {W}_{ij}}{\partial A} = - 2 {W}_{ij} {A ( {x}_{i} - {x}_{j} )}^{T} ( {x}_{i} - {x}_{j} ) \\ \frac{\partial {D}_{ii}}{\partial A} = {\sum }_{j = 1}^{n} \frac{\partial {W}_{ij}}{\partial A} & \end{matrix}$$

In one embodiment, the step-size is dynamically adapted using a gradient descent process in order to accelerate the process while guaranteeing its convergence. For example, denote the values of F and A in the t-th turn of the iterative process (illustrated with the iterative loop of FIG. 2) by Fₜ and Aₜ. If Q(Fₜ, Aₜ₋₁)>Q(Fₜ, Aₜ), i.e., if the cost function obtained after gradient descent is reduced, then the step-size is doubled; otherwise, the step-size is decreased and A is not updated, i.e., Aₜ₊₁=Aₜ.

In one embodiment, the MLCL algorithm is implemented as follows (with reference to the iterative loop shown in the analysis component 110 of FIG. 2):

1: Initialization.

1.1: Set t=0. Set η₁=1 and initialize Aₜ as a diagonal matrix

$$\frac{1}{σ} I .$$

1.2: Construct the similarity matrix Wₜ with entries computed as in the equation: Wᵢⱼ(A)=exp(−∥A(xᵢ−xⱼ∥²) discussed above.

1.3: Compute Dₜ and Sₜ accordingly.

2: Label Update (performed at the label module 206, for example).

2.1: Compute the optimal Fₜ based on δQ(F, Aₜ)/δF=0, which can be derived as:

$${F}_{t} = \frac{1}{1 + μ} {( I - \frac{μ}{1 + μ} {S}_{t} )}^{- 1} Y$$

Where μ is an adjustable positive parameter.

3: Metric update (performed at the distance metric module 204, for example).

3.1: Update Aₜ using gradient descent and adjust the step-size.

3.2: Let

$${A}_{t + 1} = {A}_{t} - {η}_{t} \frac{\partial Q}{\partial A} {\vert}_{A = {A}_{t}} ,$$

where ηₜ is the step-size for gradient descent in t-th iteration.

3.3: If Q(Aₜ₊₁, Fₜ)>Q(Aₜ, Fₜ), let

$${{A}_{t + 1} = {A}_{t} - {η}_{t} \frac{\partial Q ( {F}_{t} , A )}{\partial A} \vert}_{A = {A}_{t}} ,$$

and ηₜ₊₁=2ηₜ;

otherwise, Aₜ₊₁=Aₜ, ηₜ₊₁=ηₜ/2.

4: After obtaining Aₜ₊₁, update the similarity matrix Wₜ₊₁ with entries computed as in the equation: Wᵢⱼ(A)=exp(−∥A(xᵢ−xⱼ∥²) discussed above. Then compute Dₜ₊₁ and Sₜ₊₁ accordingly.

5: Let t=t+1. If t>T, quit the iteration and output the classification results (i.e., label 108 of media sample 104), otherwise go to step 2. T is the pre-set iteration time.

In an example embodiment, the above iterative process converges: According to step 2, Q(Fₜ₊₁, Aₜ)<Q(Fₜ, A) can be obtained. Meanwhile, from step 3, Q(Fₜ₊₁, Aₜ₊₁)≦Q(Fₜ₊₁, Aₜ). This results in: Q(Fₜ₊₁, Aₜ₊₁)≦Q(Fₜ₊₁, Aₜ)<Q(Fₜ, Aₜ). Since Q(F, A) is lower bounded by 0, in one embodiment, the iterative process is guaranteed to converge, providing a label 108 for the unlabeled media sample 104. In an embodiment, the computational cost of the above solution process scales as O(n²D³), where n is the number of samples and D is the dimensionality of feature space. However, in some implementations, the computational cost can be reduced by enforcing the matrix W to be sparse. For example, only the N largest components in each row of W are kept, which means that each sample is only connected to its N nearest neighbors in the graph. This is a generally-applied strategy which can reduce computational cost while retaining performance. By applying this strategy, the computational cost can be reduced to O(nND³).

### Dimensionality Reduction

In some embodiments, dimensionality reduction of input data is used as a pre-processing step for machine learning algorithms. In alternate embodiments, various dimensionality reduction methods may be used, such as Principle Component Analysis (PCA), Linear Discriminant Analysis (LDA) and Locally Linear Embedding (LLE). These methods may be categorized into supervised and unsupervised approaches according to whether label information is used. In one embodiment, the MLCL algorithm can also be applied to reduce dimensionality. By restricting A to be a non-square matrix of size d×D(d<D), MLCL may be applied to reduce linear dimensionality. In one embodiment, the rank of the learned metric M is d, and the media samples 104 can be transformed from the space in R^{D} to R^{d}. This approach may be viewed as a semi-supervised dimensionality reduction method, since both labeled samples 208 and unlabeled samples 104 are involved. By selecting d=2 or d=3, useful low dimensional visualizations on all samples can be computed.

### Illustrative Processes

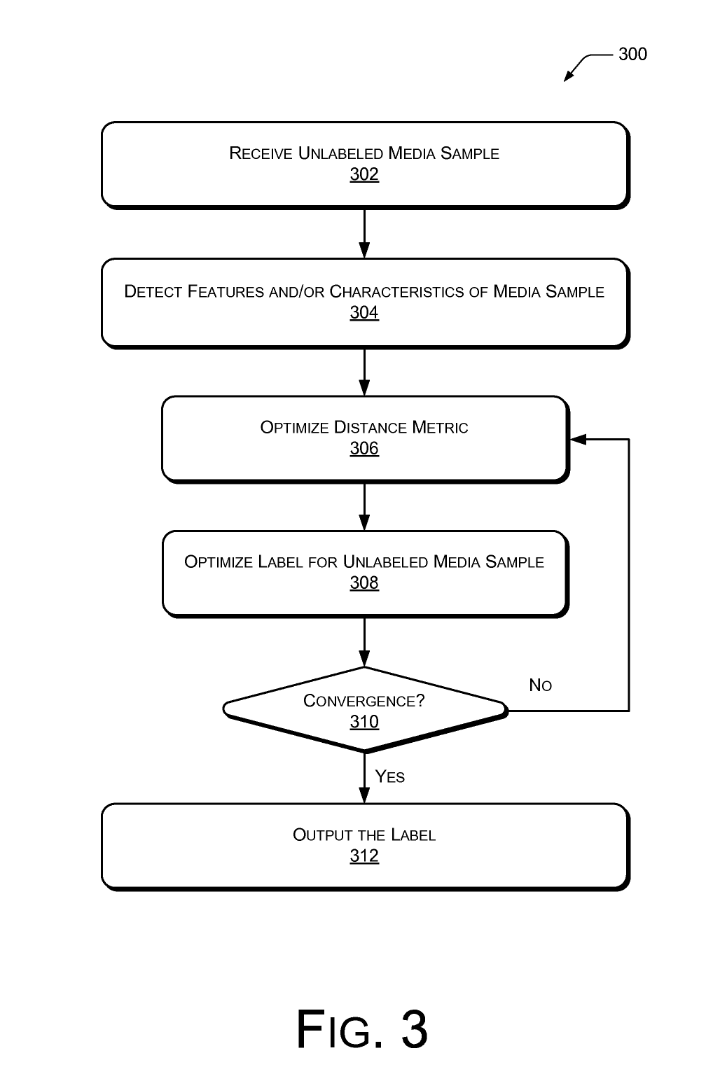

FIG. 3 illustrates an example process 300 of determining a label for a media sample, according to an example embodiment. While the example processes are illustrated and described herein as a series of blocks representative of various events and/or acts, the subject matter disclosed is not limited by the illustrated ordering of such blocks. For instance, some acts or events may occur in different orders and/or concurrently with other acts or events, apart from the ordering illustrated herein. In addition, not all illustrated blocks, events or acts, may be required to implement a methodology in accordance with an embodiment. Moreover, it will be appreciated that the example processes and other processes according to the disclosure may be implemented in association with the processes illustrated and described herein, as well as in association with other systems and apparatus not illustrated or described. For example, the process 300 may be implemented as computer executable instructions stored on one or more computer readable storage media, as discussed above, or the like.

In the illustrated example implementation, the media sample is described as an image or a video. However, the illustrated process 300 is also applicable to automatically determining labels for other objects or data forms (e.g., web data object, a music file, etc.).

At block 302, a system or device (such as the system 102, for example) receives an unlabeled media sample (such as the media sample 104, for example). In one embodiment, the unlabeled media sample is received as potential training data for a machine learning process.

At block 304, the system or the device detects one or more features and/or characteristics of the media sample. Detection techniques (using detection module 202, for example) may be employed to detect features and characteristics of the media sample received, such as color, sound, texture, motion, and the like. In alternate embodiments, various techniques may be employed to detect features and/or characteristics of the media sample (e.g., text recognition, face recognition, graphical comparisons, color or shape analysis, line vector analysis, audio sampling, web-based discovery, etc.). In other implementations, the features and characteristics of the media sample are provided or available (e.g., in an information database, in accompanying notes, etc.).

At block 306, the process includes iteratively optimizing a distance metric for the unlabeled media sample (using the distance metric module 204 for example). In one embodiment, the process includes using the features and characteristics of the received unlabeled media sample with features and/or characteristics of other unlabeled media samples and/or other known labeled media samples (such as media samples 208) to optimize the distance metric. For example, an algorithm may be used that determines a Mahalanobis distance metric. The known labeled media samples may be collected from a network, for example, such as the Internet. In alternate embodiments, the known labeled media samples may be collected from one or more data stores, such as optical or magnetic data storage devices, and the like.

At block 308, the process includes iteratively optimizing a label for the unlabeled media sample (using the label module 206 for example) in conjunction with the optimizing the distance metric at block 306. For example, in one embodiment, the process includes using the features and characteristics of the received unlabeled media sample with features and/or characteristics of other unlabeled media samples and/or other known labeled media samples (such as media samples 208) to optimize the label for the unlabeled media sample. In one embodiment, an algorithm may be used that determines a label based on the distance metric. For example, a label may be determined for the unlabeled media sample based on the closeness of a neighboring sample, where the closeness is based on the distance metric. In one implementation, the process 300 performs the step of block 306 and the step of block 308 simultaneously or nearly simultaneously.

In some embodiments, iterative techniques are used that update the distance metric (with respect to block 306) and update the label (with respect to block 308) in iterative succession, until convergence in the algorithm used is reached. This is represented by the decision block 310. Until convergence is reached in the optimization algorithm, the process continues to update the distance metric (at block 306) and update the label (at block 308). At least one example optimization algorithm that may be used in an example process 300 is described above with reference to FIG. 2. In alternate embodiments, variations on the optimization algorithm described, or other optimization algorithms, may be used to determine a label for a media sample. When the algorithm used reaches convergence, the last label (the optimized label) determined in block 308 at the point of convergence is output.

At block 312, the optimized label (such as label 108) is output. In one embodiment, the output of the system 102 is displayed on a display device and/or stored in association with the media sample. In alternate embodiments, the label may be output to a user and/or a system in various other forms (e.g., email, posting to a website, posting on a social network page, text message, etc.). For example, the output may be in various electronic or hard-copy forms. In one embodiment, the output label is included in a searchable, annotated database that includes classifications, indexing, and the like. In an embodiment, the label is output as part of a set of training data for a machine learning process.

### CONCLUSION

Although implementations have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations. For example, the methodological acts need not be performed in the order or combinations described herein, and may be performed in any combination of one or more acts.

1. A system for automatically determining a label for an unlabeled media sample, the system comprising:
a processor;
memory coupled to the processor;
an analysis component stored in the memory and operable on the processor to:
receive the media sample;
detect at least one characteristic of the media sample;
optimize a distance metric based at least in part on the detecting; and
optimize, simultaneously with the optimizing of the distance metric, a label for the media sample based at least in part on the detecting and the distance metric; and
an output component stored in the memory and operable on the processor to output the label for the media sample.

2. The system of claim 1, wherein the analysis component is further operable on the processor to optimize the distance metric and the label in a converging iterative loop based on a predetermined algorithm.

3. The system of claim 2, wherein the analysis component is further operable on the processor to use a gradient descent process configured to dynamically adapt a step size of the converging iterative loop.

4. The system of claim 1, wherein the distance metric represents a similarity between the unlabeled media sample and a neighboring sample.

5. The system of claim 1, wherein the distance metric is a Mahalanobis distance metric.

6. The system of claim 1, wherein the analysis component is further operable on the processor to receive at least one labeled media sample.

7. One or more computer-readable storage media comprising computer executable instructions that, when executed by a computer processor, direct the computer processor to perform operations including:
receiving an unlabeled media sample;
detecting a characteristic of the media sample;
automatically determining a label for the media sample based at least in part on the detecting and at least in part on an iterative converging algorithm; and
outputting the label for the media sample.

8. The one or more computer-readable storage media of claim 7, wherein the algorithm includes updating a distance metric and updating the label based at least in part on the distance metric, in iterative succession until convergence in the algorithm.

9. The one or more computer-readable storage media of claim 8, wherein the algorithm includes simultaneously updating the distance metric and updating the label.

10. The one or more computer-readable storage media of claim 7, wherein the algorithm includes using a Mahalanobis distance metric.

11. The one or more computer-readable storage media of claim 7, wherein the characteristic includes one of: color, sound, texture, or motion.

12. The one or more computer-readable storage media of claim 7, wherein the outputting includes outputting training data for a machine learning process, the training data based at least in part on the label.

13. The one or more computer-readable storage media of claim 7, further comprising computing a similarity between the media sample and a neighboring media sample.

14. The one or more computer-readable storage media of claim 7, further comprising using the algorithm to reduce a dimensionality of input data, the dimensionality being reduced based at least in part on restricting a size of a matrix used in the algorithm.

15. The one or more computer-readable storage media of claim 7, further comprising training a binary classification model with a support vector machine (SVM), the training including training data based at least in part on the label.

16. The one or more computer-readable storage media of claim 7, wherein the iterative converging algorithm comprises the equation:
Wᵢⱼ=exp(−(xᵢ−xⱼ)^{T}M(xᵢ−xⱼ))
wherein Wᵢⱼ indicates a similarity measure between xᵢ and xⱼ, xᵢ and xⱼ represent characteristics of media samples, T is an iteration time, and M represents a symmetric positive semi-definite real matrix.

17. A computer-implemented method of producing training data for a machine learning process, the method comprising:
receiving a first media sample, the first media sample being unlabeled;
receiving a second media sample;
iteratively performing optimizing steps according to an algorithm until convergence of the algorithm, the optimizing steps including:
computing a distance metric based at least in part on a first characteristic of the first media sample and a second characteristic of the second media sample; and
determining, at least partly while computing the distance metric, a label for the first media sample based at least in part on the distance metric; and
outputting the training data based at least in part on the label.

18. The method of claim 17, wherein the algorithm includes a gradient descent process configured to dynamically adapt a step size of the iteratively performed optimizing steps.

19. The method of claim 17, further comprising:
computing a vector score for a potential label for the first media sample, the vector score based at least in part on a Mahalanobis distance metric; and
applying the potential label to the first media sample when the vector score exceeds a predetermined threshold.

20. The method of claim 17, further comprising propagating a label from the first media sample to a neighboring media sample based at least in part on a similarity of a characteristic of the neighboring media sample to the first media sample and the distance metric.
